(19) United States
(12) Patent Application Publication
(10) Pub. No.: US 2015/0300870 A1
(43) Pub. Date: Oct. 22, 2015

(54) LIQUID SURFACE LEVEL SENSOR ATTACHMENT STRUCTURE AND LIQUID SURFACE LEVEL SENSOR

(71) Applicant: YAZAKI CORPORATION, Tokyo (JP)

(72) Inventors: Toshiaki Fukuhara, Shizuoka (JP); Shinpei Kato, Shizuoka (JP); Ryo Hirose, Shizuoka (JP)

(21) Appl. No.: 14/754,834

(22) Filed: Jun. 30, 2015

Related U.S. Application Data
(63) Continuation of application No. PCT/JP2014/050648, filed on Jan. 16, 2014.

(30) Foreign Application Priority Data
Jan. 18, 2013 (JP) 2013-006939

(51) Int. Cl. G01F 23/72

(52) U.S. Cl. CPC G01F 23/72

(57) ABSTRACT

A liquid surface level sensor includes a plurality of piece portions provided at both ends of the liquid surface level sensor in a width direction, and a plurality of elastically deformable hook portions formed to elongate from both end sides in a first height direction. A pump holder includes a plurality of claw portions formed in a claw shape by bending front end sides in an intra-width direction of the liquid surface level sensor, and a plurality of convex portions on a side of the first height direction of the plurality of claw portions. A plurality of hook portions is elastically deformed in contact with the plurality of convex portions by sliding the liquid surface level sensor in a second height direction, the plurality of hook portions gets over the plurality of convex portions and restores from an elastically deformed state by further sliding the liquid surface level sensor.

### TECHNICAL FIELD

The present invention relates to a liquid surface level sensor attachment structure and a liquid surface level sensor.

### BACKGROUND ART

Conventionally, a liquid surface level sensor which detects a liquid surface level in a tank has been proposed. Various methods of attaching such a liquid surface level sensor in a tank have been proposed. For example, a structure which fixes a liquid surface level sensor to a desired position by forming hooks and slide grooves in an inner wall of a tank, sliding the liquid surface level sensor along the slide grooves and fixing the liquid surface level sensor by the hooks has been proposed (see, for example, Patent Literature 1). Note that this liquid surface level sensor is attached to a pump holder which has a built-in pump which feeds a fuel or the like in the tank to the outside, and this pump holder is assembled to an opening portion of the tank to form a closed space for holding a liquid such as a fuel.

### CITATION LIST

### Patent Literature

Patent Literature 1: JP 4591360 A

### SUMMARY OF INVENTION

### Technical Problem

However, in a liquid surface level sensor attachment structure disclosed in Patent Literature 1, slide grooves and hooks are formed at a liquid surface level sensor attachment object side, and therefore a complex shape needs to be formed at the attachment object side.

Further, when the hooks are damaged upon attachment of the liquid surface level sensor, a pump holder which is larger and costlier than the liquid surface level sensor needs to be exchanged.

The present invention has been made to solve such a conventional problem. An object of the present invention is to provide a liquid surface level sensor attachment structure and a liquid surface level sensor which can simplify an attachment object-side structure, and prevent a situation that a costly part is exchanged even when the structure is damaged.

### Solution to Problem

A liquid surface level sensor attachment structure according to the present invention is an attachment structure which includes a liquid surface level sensor detecting a liquid surface level in a tank, and a pump holder including a pump that discharges a liquid contained in the tank and serves as an attachment object of the liquid surface level sensor, the liquid surface level sensor attachment structure attaching the liquid surface level sensor to the pump holder, wherein the liquid surface level sensor includes a plurality of piece portions provided at both ends in width direction of the liquid surface level sensor, and a plurality of elastically deformable hook portions provided at both end sides in the width direction and formed to elongate from the both end sides in a first height direction, the first height direction being one of height directions, the pump holder includes a plurality of claw portions projecting to inside of the tank and formed in a claw shape by bending front end sides in an intra-width direction of the liquid surface level sensor, and a plurality of convex portions projecting to inside of the tank in the first height direction side of the plurality of claw portions, and the plurality of hook portions is elastically deformed in contact with the plurality of convex portions by sliding the liquid surface level sensor in a second height direction, the second height direction being the other of the height directions, the plurality of hook portions gets over the plurality of convex portions and restores from an elastically deformed state by further sliding the liquid surface level sensor, and the plurality of piece portions fits to the plurality of claw portions in the restored state.

According to this liquid surface level sensor attachment structure, the plurality of hook portions gets over the plurality of convex portions and restores from the elastically deformed state. Therefore, in this state, movement of the liquid surface level sensor in the first height direction is regulated when the plurality of hook portions interferes with the plurality of convex portions, and the plurality of piece portions fits to the plurality of claw portions in the restored state. Consequently, movement in the width direction and in a depth direction is regulated and the liquid surface level sensor is attached to the pump holder. Upon this attachment in particular, the hook portions are provided to the liquid surface level sensor, so that it is not necessary to provide the hook portions to the pump holder and, even when the hook portions are damaged, exchanging the liquid surface level sensor makes it unnecessary to exchange the pump holder. Consequently, it is possible to simplify an attachment object-side structure and prevent a situation that a costly part is exchanged even when the structure is damaged.

Further, in the liquid surface level sensor attachment structure according to the present invention, preferably, each of the plurality of convex portions is provided spaced at an interval corresponding to each of the hook portions apart from the plurality of claw portions in the first height direction.

According to this liquid surface level sensor attachment structure, preferably, each of the plurality of convex portions is provided spaced at an interval corresponding to each of the hook portions apart from the plurality of claw portions in the first height direction. Hence, when the plurality of hook portions gets over the plurality of convex portions and restores from the elastically deformed state, the plurality of claw portions is positioned near or in contact with rear end sides of the plurality of hook portions. Consequently, not only movement of the liquid surface level sensor in the first height direction is regulated when the plurality of hook portions interferes with the plurality of convex portions, but also movement in the second height direction is regulated when the rear end sides of the plurality of hook portions interfere with the plurality of claw portions. Consequently, it is possible to more firmly attach the liquid surface level sensor.

Further, in the liquid surface level sensor attachment structure according to the present invention, preferably, the piece portions is provided in plural at each of the both ends of the liquid surface level sensor, and the claw portions, a number of which corresponds to a number of the piece portions, are provided to the pump holder.

According to this liquid surface level sensor attachment structure, the piece portions is provided in plural at each of the both ends of the liquid surface level sensor, and the claw portions, a number of which corresponds to a number of the piece portions, are provided to the pump holder. Hence, the both ends of the liquid surface level sensor are fixed at a plurality of portions, and movement in a rotation direction is also regulated. Consequently, it is possible to more firmly attach the liquid surface level sensor.

Further, in the liquid surface level sensor attachment structure according to the present invention, preferably, the plurality of claw portions is formed such that a distance between an inner wall of the tank and an opposing surface thereof gradually becomes shorter toward the second height direction.

According to this liquid surface level sensor attachment structure, the plurality of claw portions is formed such that a distance between an inner wall of the tank and an opposing surface thereof gradually becomes shorter toward the second height direction. Hence, when the liquid surface level sensor is slid to attach to the pump holder, the piece portions are pressed fit in the claw portions, and, when the attachment is finished, the piece portions are firmly sandwiched between the claw portions and the tank inner wall. Consequently, it is possible to more firmly attach the liquid surface level sensor.

Further, a liquid surface level sensor according to the present invention detects a liquid surface level in a tank, and is attached to a pump holder configured to include a pump discharging a liquid contained in the tank, and includes: a plurality of piece portions provided at each of both ends of the liquid surface level sensor in width direction; and a plurality of elastically deformable hook portions provided at both end sides in the width direction, and formed to elongate from the both end sides in a first height direction, the first height direction being one of height directions.

This liquid surface level sensor includes the plurality of piece portions and the plurality of hook portions. By providing to the pump holder a configuration which fixes the liquid surface level sensor through the plurality of piece portions and the plurality of hook portions, it is possible to attach the liquid surface level sensor to the pump holder. Upon this attachment in particular, the hook portions are provided to the liquid surface level sensor, so that it is not necessary to provide the hook portions to the pump holder, and, even when the hook portions are damaged, exchanging the liquid surface level sensor makes it unnecessary to exchange the pump holder. Consequently, it is possible to simplify an attachment object-side structure and prevent a situation that a costly part is exchanged even when the structure is damaged.

### Advantageous Effects of Invention

According to the present invention, it is possible to provide a liquid surface level sensor attachment structure and a liquid surface level sensor which can simplify an attachment object-side structure, and prevent a situation that a costly part is exchanged even when the structure is damaged.

### BRIEF DESCRIPTION OF DRAWINGS

FIG. 1 is a perspective view illustrating a liquid surface level sensor attachment structure according to an embodiment of the present invention.

FIG. 2 is a front view of the liquid surface level sensor according to the present embodiment.

FIG. 3 is a front view of a pump holder to be an attachment object of the liquid surface level sensor.

FIG. 4 is an A-A cross-sectional view of FIG. 3.

FIG. 5 is a front view illustrating a state where the liquid surface level sensor is not yet attached.

FIG. 6 is a front view illustrating a state where the liquid surface level sensor is attached.

### DESCRIPTION OF EMBODIMENTS

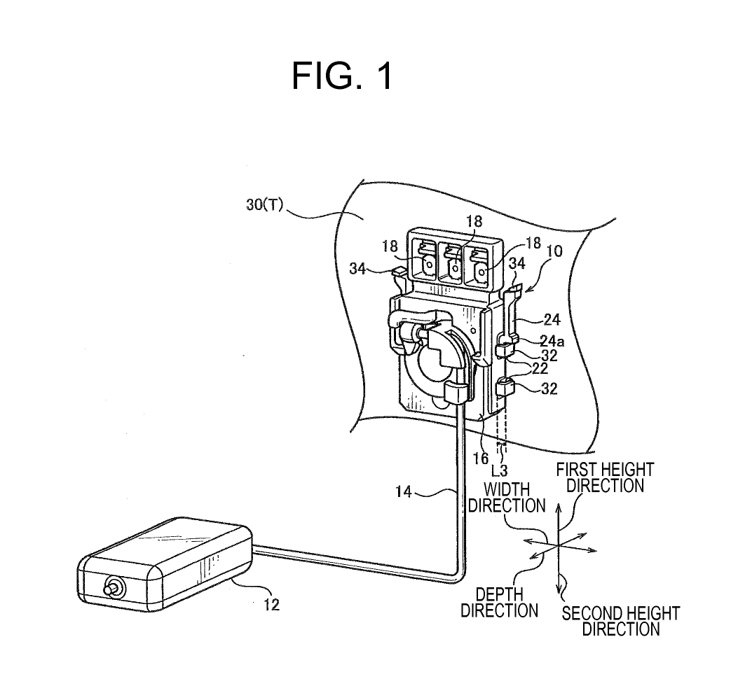

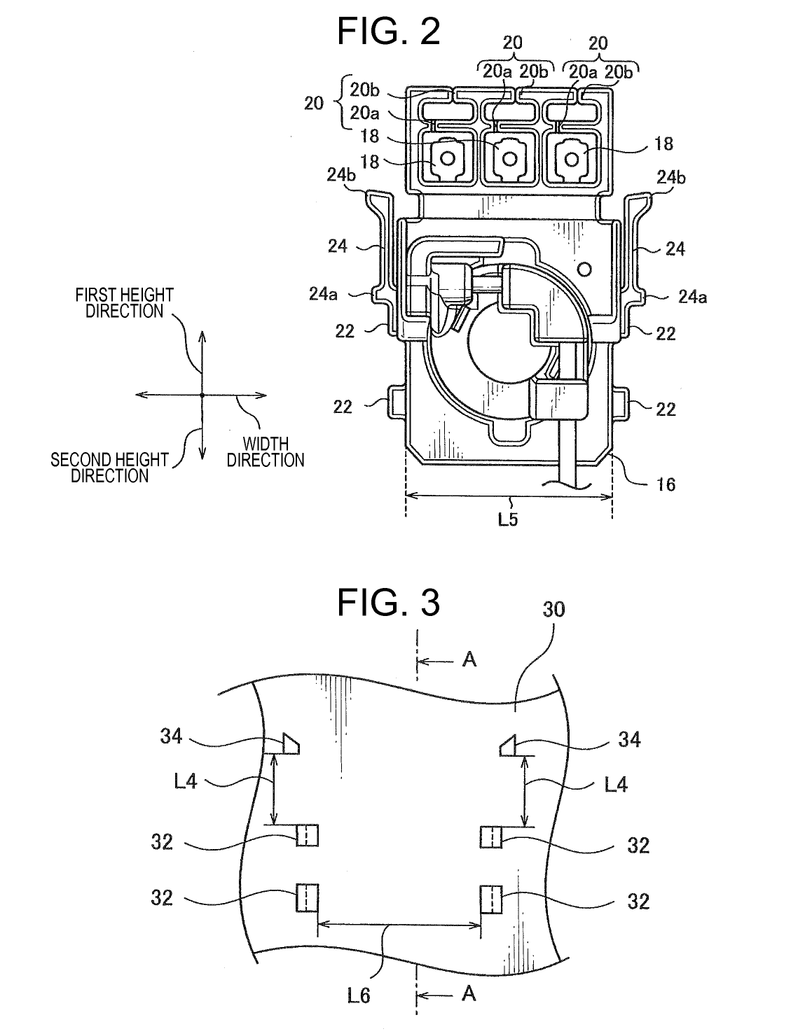

A preferred embodiment of the present invention will be described below with reference to the drawings. Note that, although the present invention will be described below based on the embodiment, the present invention is not limited to the embodiment. FIG. 1 is a perspective view illustrating a liquid surface level sensor attachment structure according to an embodiment of the present invention, FIG. 2 is a front view of a liquid surface level sensor according to the present embodiment, and FIG. 3 is a front view of a pump holder to be an attachment object of the liquid surface level sensor.

Note that, although a liquid surface level sensor attachment structure which detects a vehicle fuel level will be described as an example in the following embodiment, the present invention is not limited to vehicle use, and may be used for other usages.

As illustrated in FIGS. 1 and 2, a liquid surface level sensor 10 detects a liquid surface level in a tank T, and includes a float 12 and an arm 14. The float 12 moves up and down following a fluctuation of the liquid surface level in the tank T. The arm 14 has one end connected to the float 12, and has the other end connected to a main body 16 of the liquid surface level sensor 10.

The main body 16 of the liquid surface level sensor 10 includes a magnet (not illustrated) which makes rotation movement according to a motion of the arm 14, and a hall element. When the liquid surface level in the tank T changes, the magnet is rotated through the arm 14. Thus, a magnetic flux density of a magnetic field which passes through the hall element changes, and then a hall voltage outputted from the hall element changes. Thus, the liquid surface level is detected.

Further, the main body 16 of the liquid surface level sensor 10 includes a plurality of terminals 18 above the main body 16, and a plurality of lead wire insertion portions 20. Each of the plurality of terminals 18 has one end connected to a terminal of the hall element, and the other end to a connector (not illustrated) through a lead wire. The lead wire insertion portion 20 is a portion through which the lead wire elongated from the terminal 18 is inserted. This lead wire insertion portion 20 is formed by a first insertion portion 20a and a second insertion portion 20b, and the respective insertion portion are formed by being displaced in a width direction.

Further, the main body 16 of the liquid surface level sensor 10 includes a plurality of piece portions 22 provided at both ends of the liquid surface level sensor 10 in the width direction, and a plurality of elastically deformable hook portions 24 provided at both end sides in the width direction and formed to elongate in a first height direction, the first height direction being one side of the height direction, and which can.

With regard to the plurality of piece portions 22, two piece portions 22 are provided at each of the both ends of the main body 16 of the liquid surface level sensor 10 as illustrated in FIGS. 1 and 2. The individual piece portion 22 is formed thinner than the main body 16 of the liquid surface level sensor 10 in a depth direction.

With regard to the plurality of hook portions 24, one hook portion 24 is provided at each of the both ends of the main body 16 of the liquid surface level sensor 10, and is formed in a cantilever shape supported at a nearly intermediate portion of the liquid surface level sensor 10 in the height direction. Further, each of the plurality of hook portions 24 includes at a rear end side a protruded portion 24a which protrudes in the width direction. Furthermore, each of the plurality of hook portions 24 includes at a front end side an expanded portion 24b which is thick.

Still further, a pump holder 30 illustrated in FIGS. 1 and 3 includes a pump (not illustrated) which feeds a fuel inside the tank T to the outside, and the pump holder 30 is a portion to be an attachment object of the liquid surface level sensor 10. This pump holder 30 includes a plurality of claw portions 32, and a plurality of convex portions 34.

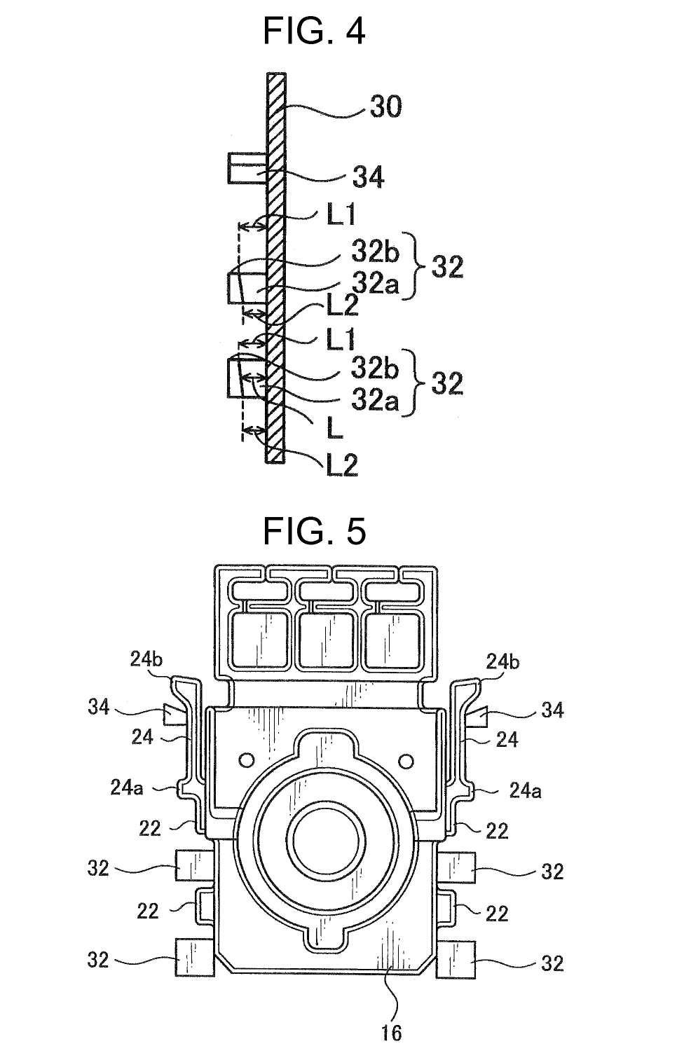

FIG. 4 is an A-A cross-sectional view of FIG. 3. As illustrated in FIGS. 3 and 4, each of the plurality of claw portions 32 is formed by a base portion 32a projecting to the inside of the tank and a front end-side bent portion 32b bent in an intra-width direction of the liquid surface level sensor 10, and is formed in a claw shape as a whole. These claw portions 32 are provided to correspond to the piece portions 22 of the liquid surface level sensor 10. Two of the claw portions 32 are formed on each of the left and right as illustrated in FIG. 3.

Further, as illustrated in FIG. 4, the plurality of claw portions 32 is formed such that a distance L between an inner wall of the tank T and an opposing surface S thereof gradually becomes shorter toward a second height direction. More specifically, the plurality of claw portions 32 is formed such that the distance L takes L1 at a first height direction end portion, and the distance L takes L2 at a second height direction end portion. Further, the thickness of the piece portion 22 of the liquid surface level sensor 10 takes L3 (L1>L3>L2).

The plurality of convex portions 34 is a plurality of projection portions projecting on the first height direction side of the plurality of claw portions 32 and to the inside of the tank T, and has a laterally-facing trapezoidal shape when seen from the front in the present embodiment. Each of the plurality of these convex portions 34 is provided spaced an interval L4 corresponding to the hook portion 24 apart from the plurality of claw portions 32 in the first height direction.

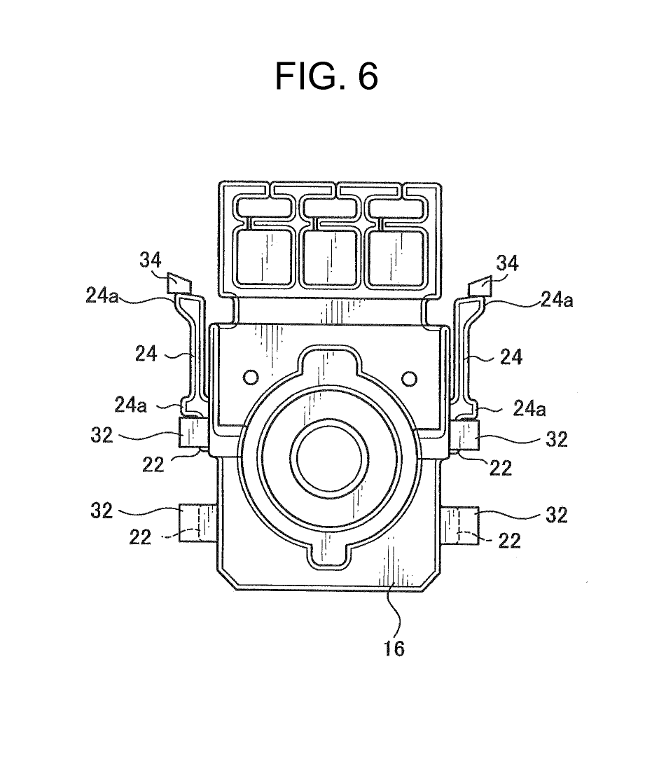

Next, a method of attaching the liquid surface level sensor 10 will be described. FIG. 5 is a front view illustrating a state where the liquid surface level sensor 10 is not yet attached, and FIG. 6 is a front view illustrating a state where the liquid surface level sensor 10 is attached.

First, as illustrated in FIG. 5, the liquid surface level sensor 10 is pressed against the pump holder 30 such that the plurality of piece portions 22 does not interfere with the plurality of claw portions 32. More specifically, the liquid surface level sensor 10 is pressed against the pump holder 30 such that front ends of the plurality of hook portions 24 are positioned slightly close to the first height direction side of the plurality of convex portions 34, and the piece portions 22 at the second height method side among the plurality of piece portions 22 provided at the both ends are positioned between the plurality of claw portions 32.

Next, the liquid surface level sensor 10 is slid in the second height direction. In this regard, a width L5 of the main body 16 of the liquid surface level sensor 10 is substantially the same as a distance L6 between the claw portions 32. Hence, the liquid surface level sensor 10 is guided by the front end-side bent portions 32b of the claw portions 32.

Further, sliding the liquid surface level sensor 10 places the expanded portions 24b of the plurality of hook portions 24 in contact with the plurality of convex portions 34, and the plurality of hook portions 24 elastically deforms in the intra-width direction of the liquid surface level sensor 10.

Furthermore, when the liquid surface level sensor 10 is slid in the second height direction from this state, the expanded portions 24b of the plurality of hook portions 24 get over the plurality of convex portions 34 and restore from the elastically deformed state. Consequently, as illustrated in FIG. 6, movement of the liquid surface level sensor 10 in the first height direction is regulated.

Further, as illustrated in FIG. 6, the plurality of piece portions 22 fits to the plurality of claw portions 32 in a restored state of the plurality of hook portions 24. Thus, movement of the liquid surface level sensor 10 in the width direction and in the depth direction is regulated, and thereby the liquid surface level sensor 10 is attached to the pump holder 30.

Further, as illustrated in FIG. 6, in the restored state of the plurality of hook portions 24, the protruded portions 24a of the plurality of hook portions 24 are positioned near or in contact with the base portions 32a of the plurality of claw portions 32. Hence, movement of the liquid surface level sensor 10 in the second height direction is also regulated.

Further, at each end, the piece portion 22 fits to the claw portion 32 at a plurality of portions. Therefore, the both ends of the liquid surface level sensor 10 are fixed at a plurality of portions, and movement in the rotation direction is also regulated.

In addition, the plurality of claw portions 32 is formed such that the distance L between the inner wall of the tank T and the opposing surface thereof gradually becomes shorter toward the second height direction. Consequently, the piece portions 22 are pressed fit in the claw portions 32, and thereby the liquid surface level sensor 10 is more firmly attached.

Note that, although the liquid surface level sensor 10 according to the present embodiment is configured to be guided by the front end-side bent portions 32b of the claw portions 32, it goes without saying that the liquid surface level sensor 10 is guided by collaboration of the piece portions 22 and the claw portions 32 at a stage at which the piece portions 22 approach the claw portions 32.

Thus, in the attachment structure of the liquid surface level sensor 10 according to the present embodiment, the plurality of hook portions 24 gets over the plurality of convex portions 34 and restores from an elastically deformed state. Therefore, in this state, movement of the liquid surface level sensor 10 in the first height direction is regulated when the plurality of hook portions 24 interferes with the plurality of convex portions 34, and the plurality of piece portions 22 fits to the plurality of claw portions 32 in a restored state. Consequently, movement in the width direction and in the depth direction is regulated, and thereby the liquid surface level sensor 10 is attached to the pump holder 30. Upon this attachment in particular, the hook portions 24 are provided to the liquid surface level sensor 10, so that it is not necessary to provide the hook portions 24 to the pump holder 30, and, even when the hook portions 24 are damaged, exchanging the liquid surface level sensor 10 makes it unnecessary to exchange the pump holder 30. Consequently, it is possible to simplify an attachment object-side structure and prevent a situation that a costly part is exchanged even when the structure is damaged.

Further, each of the plurality of convex portions 34 is provided spaced an interval corresponding to each of the hook portions 24 apart from the plurality of claw portions 32 in the first height direction. Therefore, when the plurality of hook portions 24 gets over the plurality of convex portions 34 and restores from an elastically deformed state, the plurality of claw portions 32 is positioned near or in contact with the rear end sides of the plurality of hook portions 24. Thus, not only movement of the liquid surface level sensor 10 in the first height direction is regulated when the plurality of hook portions 24 interferes with the plurality convex portions 34, but also movement in the second height direction is also regulated when the rear end sides of the plurality of hook portions 24 interfere with the plurality of claw portions 32. Consequently, it is possible to more firmly attach the liquid surface level sensor 10.

Further, the plurality of piece portions 22 is provided at the both ends of the liquid surface level sensor 10, and the plurality of claw portions 32 the number of which corresponds to the number of piece portions 22 is provided to the pump holder 30. Hence, the both ends of the liquid surface level sensor 10 are fixed at a plurality of portions, and movement in the rotation direction is also regulated. Consequently, it is possible to more firmly attach the liquid surface level sensor 10.

Further, the plurality of claw portions 32 is formed such that the distance L between the inner wall of the tank T and the opposing surface thereof gradually becomes shorter toward the second height direction. Hence, when the liquid surface level sensor 10 is slid to attach to the pump holder 30, the piece portions 22 are pressed fit in the claw portions 32, and, when the attachment is finished, the piece portions 22 are strongly sandwiched by the claw portions 32 and the inner wall of the tank T. Consequently, it is possible to more firmly attach the liquid surface level sensor 10.

Further, the liquid surface level sensor 10 according to the present embodiment includes the plurality of piece portions 22 and the plurality of hook portions 24. Therefore, by providing to the pump holder 30 a configuration which fixes the liquid surface level sensor 10 through the plurality of piece portions 22 and the plurality of hook portions 24, it is possible to attach the liquid surface level sensor 10 to the pump holder 30. Upon this attachment in particular, the hook portions 24 are provided to the liquid surface level sensor 10, so that it is not necessary to provide the hook portions 24 to the pump holder 30, and, even when the hook portions 24 are damaged, exchanging the liquid surface level sensor 10 makes it unnecessary to exchange the pump holder 30. Consequently, it is possible to simplify an attachment object-side structure and prevent a situation that a costly part is exchanged even when the structure is damaged.

The present invention has been described above based on the embodiment. However, the present invention is not limited to the above embodiment, and may be changed without departing from the spirit of the present invention.

For example, although the liquid surface level sensor 10 is slid downward in the drawings in the above embodiment, the present invention is not limited to this, and the liquid surface level sensor 10 may be slid upward. In this case, the upward refers to the second height direction. Further, the present invention is not limited to a case where the liquid surface level sensor 10 is slid in a vertical direction, and the liquid surface level sensor 10 may be slid in a lateral direction in the drawings. In this case, the lateral direction is the second height direction.

Further, each component is not limited to the dimension, the shape and the like illustrated in the drawings, and can be optionally changed as long as each component exhibits a function for achieving the object of the present invention.

### REFERENCE SIGNS LIST

10 liquid surface level sensor
12 float
14 arm
16 main body
18 a plurality of terminals
20 lead wire insertion portion
20a first insertion portion
20b second insertion portion
22 a plurality of piece portions
24 a plurality of hook portions
24a protruded portion
24b expanded portion
30 pump holder
32 a plurality of claw portions
32a base portion
32b bent portion
34 a plurality of convex portions
T tank

1. A liquid surface level sensor attachment structure comprising:
a liquid surface level sensor detecting a liquid surface level in a tank, and
a pump holder including a pump that discharges a liquid contained in the tank and serves as an attachment object of the liquid surface level sensor, the liquid surface level sensor attachment structure attaching the liquid surface level sensor to the pump holder, wherein
the liquid surface level sensor includes a plurality of piece portions provided at both ends in width direction of the liquid surface level sensor, and a plurality of elastically deformable hook portions provided at both end sides in the width direction and formed to elongate from the both end sides in a first height direction, the first height direction being one of height directions,
the pump holder includes a plurality of claw portions projecting to inside of the tank and formed in a claw shape by bending front end sides in an intra-width direction of the liquid surface level sensor, and a plurality of convex portions projecting to inside of the tank in the first height direction side of the plurality of claw portions, and
the plurality of hook portions is elastically deformed in contact with the plurality of convex portions by sliding the liquid surface level sensor in a second height direction, the second height direction being the other of the height directions, the plurality of hook portions gets over the plurality of convex portions and restores from an elastically deformed state by further sliding the liquid surface level sensor, and the plurality of piece portions fits to the plurality of claw portions in the restored state.

2. The liquid surface level sensor attachment structure according to claim 1, wherein each of the plurality of convex portions is provided spaced at an interval corresponding to each of the hook portions apart from the plurality of claw portions in the first height direction.

3. The liquid surface level sensor attachment structure according to claim 1, wherein
the piece portions is provided in plural at each of the both ends of the liquid surface level sensor, and
the claw portions, a number of which corresponds to a number of the piece portions, are provided to the pump holder.

4. The liquid surface level sensor attachment structure according to claim 2, wherein
the piece portions is provided in plural at each of the both ends of the liquid surface level sensor, and
the claw portions, a number of which corresponds to a number of the piece portions, are provided to the pump holder.

5. The liquid surface level sensor attachment structure according to claim 1, wherein the plurality of claw portions is formed such that a distance between an inner wall of the tank and an opposing surface thereof gradually becomes shorter toward the second height direction.

6. The liquid surface level sensor attachment structure according to claim 2, wherein the plurality of claw portions is formed such that a distance between an inner wall of the tank and an opposing surface thereof gradually becomes shorter toward the second height direction.

7. The liquid surface level sensor attachment structure according to claim 3, wherein the plurality of claw portions is formed such that a distance between an inner wall of the tank and an opposing surface thereof gradually becomes shorter toward the second height direction.

8. The liquid surface level sensor attachment structure according to claim 4, wherein the plurality of claw portions is formed such that a distance between an inner wall of the tank and an opposing surface thereof gradually becomes shorter toward the second height direction.

9. A liquid surface level sensor configured to detect a liquid surface level in a tank, and to be attached to a pump holder including a pump configured to discharge a liquid contained in the tank, the liquid surface level sensor comprising:
a plurality of piece portions provided at each of both ends of the liquid surface level sensor in width direction; and
a plurality of elastically deformable hook portions provided at both end sides in the width direction, and formed to elongate from the both end sides in a first height direction, the first height direction being one of height directions.
